(19) United States
(12) Patent Application Publication
(10) Pub. No.: US 2007/0033000 A1
(43) Pub. Date: Feb. 8, 2007

(54) Efficient non-iterative frequency domain method and system for nonlinear analysis

(75) Inventors: Shahin Farahani, Scottsdale, AZ (US); Sayfe Kiaei, Tempe, AZ (US); Nazanin Darbanian, Scottsdale, AZ (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Arizona Board of Regents, acting for and on behalf of Arizona State University

(21) Appl. No.: 11/489,102

(22) Filed: Jul. 19, 2006

Related U.S. Application Data
(60) Provisional application No. 60/700,643, filed on Jul. 19, 2005.

(51) Int. Cl. G06F 9/455

(52) U.S. Cl. 703/28

(57) ABSTRACT

A non-iterative frequency domain method for the accurate and efficient simulation of nonlinear systems is presented. In one aspect of the present invention, simulating a nonlinear system is accomplished by first modeling the system and generating parameters that describe the nonlinear system. The system is represented in the frequency domain as an inverse convolution equation (ICE), comprising cascaded convolutions and frequency representations of known and unknown signals. Next, the order of the ICE is determined based upon the degree of nonlinearity in the system. Finally, a general ICE solver algorithm is adapted to the ICE order of the frequency model, and the specific ICE solver algorithm is applied to in order to solve for an unknown signal. In another aspect of the invention, the non-iterative method for simulating nonlinear systems is combined with cross-referenced coordinate (CRC) techniques in order to increase the computational efficiency of the simulation.

### CROSS-REFERENCE TO RELATED APPLICATIONS

This application claims the benefit of the filing date of U.S. Provisional Application No. 60/700,643, filed Jul. 19, 2005, entitled “An Efficient Non-Iterative Frequency Domain Method and Tool for Nonlinear Analysis and Simulation of RF and Analog Circuits,” the disclosure of which is incorporated in its entirety by reference herein. In addition, this application is related to pending U.S. patent application Ser. No. 10/535,616, filed Nov. 21, 2003, entitled “Compressed Vector-Based Spectral Analysis Method and System for Nonlinear RF Blocks,” which is incorporated in its entirety by reference herein.

### BACKGROUND OF THE INVENTION

1. Field of the Invention

The present invention relates generally to the field of efficient algorithms and software methods for circuit analysis and simulation. More specifically, the present invention relates to efficient algorithms and software methods for the analysis and simulation of nonlinear radio frequency and analog circuits.

2. Description of the Related Art

With increasing demand for wireless technologies, the need for the basic wireless communication circuits and systems that support these technologies has also increased. In addition, as the use of wireless technologies has become more prevalent, consumers have increasingly demanded improved wireless components that exhibit, among other characteristics, higher transfer speeds and lower power consumption. As a result, wireless circuit designers are constantly developing new circuits and components that are able to meet these requirements. However, developing new circuits is a multi-step process that involves conceiving of a new circuit, developing a model for the circuit, simulating the circuit, and eventually fabricating the circuit. Effective simulation of circuit ensures that the circuit will operate both correctly and within the specified design parameters prior to the circuit design being sent off for fabrication. As a result, the simulation technique used to test circuit designs must be accurate. In addition, a designer will usually go through several iterations of model-refinement and simulation before a circuit is determined fit for fabrication. Therefore, in addition to accuracy, the simulation technique must also be computationally efficient in order to allow for relatively rapid determinations of circuit behavior and to reduce barriers associated with multiple and frequent circuit model refinements.

As shown above, efficient and accurate simulation methods help to facilitate the process of developing new wireless communication circuits. However, such effective methods also provide other benefits. Accurate simulation methods allow designers to investigate novel designs and to test design changes without expending time and money producing physical samples. Similarly, computationally efficient simulation methods allow for more extensive and broader testing of circuits, further contributing to the accuracy of a circuit model as compared to a resulting physical representation. In addition, efficient simulation enables larger-scale simulations at the system level, rather than requiring piecewise simulation of circuits. Therefore, the benefits resulting from the development of more accurate and efficient simulation methods are extensive.

Wireless communication circuits and systems would especially benefit from the introduction of more accurate and efficient simulation methods. Wireless communication circuits and systems often contain nonlinear devices or circuits exhibiting nonlinear behavior. Specifically, many wireless communication circuits comprise components like low noise amplifiers (LNAs) and mixers which may exhibit nonlinear behavior: low noise amplifiers (LNAs) often contain voltage sources having upper and lower bounds which limit the dynamic range of the LNA, while mixers are often subject to leakage from local oscillators, leading to potential self-mixing with the RF signal. Furthermore, both active and passive devices in wireless communication circuits may introduce nonlinearities at the device level.

Depending on the complexity of the system, the presence of nonlinearities in a circuit system may be extensive. Such nonlinearities may manifest as degradations of intermediate and output signals. Specifically, nonlinearities may introduce spectral components in the form of undesired harmonics of input signals, intermodulation, and gain compression. Undesired harmonics may negatively affect circuit operation by resulting in unpredictability and unbalanced gains. Intermodulation, particularly of undesired harmonics in a multi-tone system, may distort a signal being processed, as well as increase system complexity by requiring DC offset cancellation circuitry or complex filters. Nonlinearities may also result in reduced gain through clipping or other effects. As a result of the possible severity of such effects, it is often imperative that a designer be able to determine the extent to which nonlinearities will affect system behavior.

Due to the presence of nonlinear devices in wireless components, accurate simulation of wireless communication circuits and systems generally includes the simulation of these nonlinear elements. However, finding means for efficient and accurate simulation of nonlinear elements remains a challenging problem. And as noted above, the increasing need for wireless communication devices has only increased the need for an accurate and efficient solution.

Various techniques currently exist for analysis of nonlinear elements, including several frequency domain analysis and simulation methods. The most popular frequency domain methods include iterative techniques like Harmonic Balance (HB), Shooting Newton, and Volterra Series approaches. However, because these methods are based on iterative nonlinear solvers, they face convergence problems in some practical scenarios. As a result, these methods may not be able to solve certain nonlinear systems, or may require that the system be only weakly nonlinear in order to permit any possibility of convergence. In addition, these systems may require a user to provide an initial starting point for iterative calculations, with the possibility that different initial starting points may lead to different converging solutions. As a result, the accuracy of the above methods is not always guaranteed.

Finally, in situations where the above simulation methods are valid, application of the methods may be relatively computationally intense. Table 1 shows the computational complexity of various mathematical operations:

TABLE 1

| Operation | Computational Complexity |
|---|---|
| Polynomial summation | O(n²) |
| Direct matrix multiplication | O(n³) |
| Modified matrix multiplication | O(n²) |
| Convolution | O(n²) |
| Discrete Fourier transform (DFT) | O(n²) |
| Fast Fourier transform (FFT) | O(n log(n)) |
| Storage of a matrix | O(n²) |
| Inverse of a matrix | O(n³) |
| Factorization of a matrix | O(n³) |
| Vector multiplication | O(n) |
| Direct vector-matrix multiplication | O(n²) |

The popular HB method comprises several of the mathematical operations, including the factorization of a Jacobian matrix and calculating the inverse of the matrix as shown in Table 2:

TABLE 2

| Operation | Computational Complexity |
|---|---|
| Calculating FFT and inverse FFT | O(n log(n)) |
| Storage of a Jacobian matrix, | O(n²) |
| modified matrix multiplication | |
| Factorization of the Jacobian matrix, | O(n³) |
| calculation of the inverse matrix | |

The maximum computational complexity of an algorithm is equal to the step having the greatest computational complexity. Therefore, the maximum computational complexity of the HB method for each iteration is O(n³). A less complex solution would be able to provide increased simulation speeds. Overall, it would be desirable to remedy the foregoing and other deficiencies inherent in the prior art, and to have a nonlinear simulation and analysis framework that avoids convergence problem, is accurate, and that is also computationally efficient.

### SUMMARY OF THE INVENTION

The present invention involves a novel method for accurately and efficiently simulating non-linear systems using non-iterative techniques. These techniques overcome the convergence issues of prior simulation methods, and eliminate the iterative fast Fourier transform and inverse fast Fourier transform steps. In one aspect of the present invention, simulating a nonlinear system is accomplished by first modeling the system and generating parameters that describe the nonlinear system. Next, the system is represented as a time-varying function comprising known input and output signals, and an unknown signal. The time domain representation is then converted into the frequency domain by substituting the time domain multiplications with cascaded convolutions in the frequency domain, thereby representing the system as an inverse convolution equation (ICE). Next, the order of the ICE is determined based upon the degree of nonlinearity in the system. Finally, the general ICE solver algorithm is adapted to the order of the ICE, and the specific ICE solver algorithm is applied in order to solve for the unknown signal. In a variation on this aspect of the invention, the steps of representing the system in the time domain and converting to the frequency domain are optional, and a known frequency representation of the system comprising cascaded convolutions is generated without first generating the time-varying representation in an intermediate step.

In another aspect of the present invention, the non-iterative method for simulating non-linear systems is combined with the use of cross-referenced coordinate (CRC) transformations. In this aspect of the present invention, simulating a nonlinear system is accomplished by first modeling the system and generating parameters that describe the nonlinear system. Next, the system is represented as a time-varying function in terms of known input and output signals, and an unknown signal. The time domain representation is then converted into the frequency domain using CRC techniques by converting individual signals into CRC matrix representations and by substituting the time domain multiplications with cascaded convolutions in the frequency domain, thereby representing the system as a CRC-based ICE. Next, the order of the CRC-based ICE is determined based upon the degree of nonlinearity in the system. Finally, the general CRC-based ICE solver algorithm is adapted to the order of the CRC-based ICE, and the specific CRC-based ICE solver algorithm is applied in order to solve for the unknown signal.

### BRIEF DESCRIPTION OF THE DRAWINGS

Embodiments of the invention are described below in conjunction with the appended figures, wherein like reference numerals refer to like elements in the various figures, and wherein:

FIG. 1 is a schematic of a general circuit node, according to an embodiment of the invention;

FIG. 2 is a flow diagram illustrating a first process for simulating nonlinear systems using a non-iterative solver, according to an embodiment of the invention;

FIG. 3 is a flow diagram illustrating a second process for simulating nonlinear systems using a non-iterative solver, according to an embodiment of the invention;

FIG. 4 is a frequency magnitude representation of a limited bandwidth signal, according to an embodiment of the invention;

FIG. 5 is a schematic of a general wireless front-end system exhibiting nonlinearities, according to an embodiment of the invention;

FIG. 6 is an illustration of a geometrical representation of terms in a Fourier series expansion, according to an embodiment of the invention;

FIG. 7a is a first illustration of a geometrical representation of a single term component of a signal represented using the cross-reference coordinate (CRC) method, according to an embodiment of the invention;

FIG. 7b is a second illustration of a geometrical representation of a single term component of a signal represented using the cross-reference coordinate (CRC) method, according to an embodiment of the invention;

FIG. 8 is a schematic of a nonlinear system having a digitally modulated signal as its input, according to an embodiment of the invention;

FIG. 9 is an illustration of the arrangement of nonlinearly generated terms in a CRC matrix representation of a signal, according to an embodiment of the invention; and

FIG. 10 is a flow diagram illustrating a process for simulating nonlinear systems using a non-iterative solver and cross-reference coordinate techniques, according to an embodiment of the invention.

### DETAILED DESCRIPTION

The nonlinear solver algorithm method detailed herein provides a non-iterative approach that overcomes the limitations of the prior art because it is accurate, it guarantees convergence. The nonlinear solver algorithm involves a novel approach to solving inverse convolution equations which are prevalent in frequency representations of nonlinear systems, especially electrical circuits and particularly RF, analog, and microwave electrical circuits. As a result, the ability to solve inverse convolution equations with assured convergence allows for increased speed and accuracy in simulating nonlinear systems.

Inverse Convolution Equations

As noted above, inverse self convolution equations are generally found in frequency domain representations of nonlinear systems. There are several reasons that frequency domain analysis is the preferred method for the simulation of nonlinear systems including, but not limited to, the following. First, real world signals typically consist of both high frequency and low frequency components that may comprise wide-spaced frequency bands. Second, many high frequency systems are characterized by relatively long time constants, requiring the transient solution in the time domain to integrate over large number of periods of the lowest signal frequency with time steps dictated by highest frequency sinusoid. Finally, at higher frequencies, many linear models (e.g., distributed components) are best represented in the frequency domain. Therefore, simulating nonlinear systems in time domain can result in problems related to accuracy, causality, or stability. This is especially true for analog, RF and microwave circuits.

An inverse convolution equation (ICE) is defined as and takes the form of:

$$Y = {\sum }_{i = 0}^{I} {\sum }_{j = 0}^{J} {α}_{ij} {\prod }_{⊗}^{j} ( XA ) \qquad ( 1 )$$

where YεC^{M} is a known vector with length M, XεC^{M} is the vector of unknown state variables that need defining, A is a known block matrix, and α=[αᵢⱼ] is the known set of polynomial coefficients of the nonlinear polynomial model. Equation (1) represents a system as a summation of several sub-systems. More generally, a single summation can be used to represent the system without distinguishing the sub-system:

$$Y = {\sum }_{n = 0}^{N} {α}_{ij} {\prod }_{⊗}^{j} ( XA ) \qquad ( 2 )$$

The convolution terms of (1) and (2) are defined as:

$${\prod }_{⊗}^{n} X = \overbrace{X ⊗ X ⋯ ⊗ X}^{n}$$

where n is the order of the ICE.

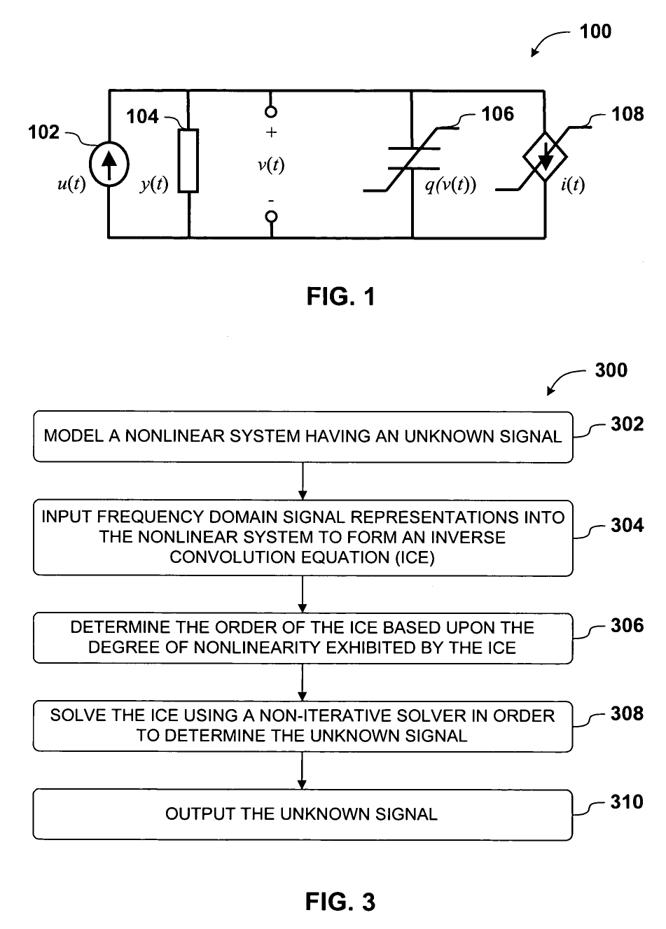

As an example of ICEs, consider a typical nonlinear analog circuit. FIG. 1 shows a general nonlinear circuit 100 comprising linear and nonlinear elements. An analysis of the node using Kirchhoff's Current Law yields the following time-domain representation of the circuit:

$$f ( v , t ) = \frac{ⅆ q ( v ( t ) )}{ⅆ t} + i ( v ( t ) ) + {\int }_{- ∞}^{t} y ( t - τ ) v ( τ ) ⅆ τ + u ( t ) = 0 \qquad ( 3 )$$

The electric charge q(v(t)) stored in the capacitor 106 represents the nonlinear function of the voltage across the junctions. Therefore,

$${i}_{C} = \frac{ⅆ q ( v ( t ) )}{ⅆ t}$$

is the nonlinear capacitor current. The nonlinear resistance and inductivity are captured by the nonlinear function i(.). All of the currents generated by the linear time-invariant (LTI) components are lumped into the term

$${\int }_{- ∞}^{t} y ( t - τ ) v ( τ ) ⅆ τ .$$

In addition, u(t) is the input current, which is known. It is assumed that v(t), u(t), i(.), v(.), and f(v,t)εC^{N}. In addition, it is assumed that v(t) and u(t) are periodic with period T. Given the known current u(t) and the known functions i(.), q(.), and y(.), the nonlinear solver system may be utilized to determine the voltage v(t) that satisfies equation (3).

As noted above, solving the equation is preferably accomplished by working with the equivalent frequency domain representation of the system. In determining the overall equivalent frequency domain representation of equation (3), each term in the equation is transformed into its equivalent frequency domain representation. Determining the frequency domain representations of v(t), y(t) and u(t) is relatively straightforward, and may be accomplished using Fourier transforms. Determining the frequency domain representations of i(.) and q(.) requires the use of self-convolution equations, as shown below.

It is given that functions i(.) and q(.) are memoryless; as a result, i(.) and q(.) can be approximated by the following polynomial functions of the input signal v(t):

$$\begin{matrix}\begin{matrix}i ( v ( t ) ) = {α}_{ 0} + {α}_{ 1} v ( t ) + {α}_{2} {v ( t )}^{2} + … + {α}_{M} ( {v ( t )}^{M} \\ = {\sum }_{m = o}^{M} {α}_{m} {v ( t )}^{m}\end{matrix} & ( 4 ) \\ \begin{matrix}q ( v ( t ) ) = {β}_{0} + {β}_{1} v ( t ) + {β}_{2} {v ( t )}^{2} + … + {β}_{M} {v ( t )}^{M} \\ = {\sum }_{m = 0}^{M} {β}_{m} {v ( t )}^{m}\end{matrix} & ( 5 )\end{matrix}$$

where αₘ and βₘ are known polynomial coefficients derived from model system parameters. Assuming the voltage v(t) can be represented by:

$$v ( t ) = {\sum }_{k = 1}^{L} {V}_{1} {ⅇ}^{{jω}_{k} t}$$

V=[V₁ V₂ . . . V_{L}]εC^{1×L}
where V is a complex vector of size L, ωₖ=2πkf₀, and f₀ is the carrier frequency, then the Fourier series transform of (4) becomes:

$$\begin{matrix}{𝒥}_{S} \{ i ( v ( t ) ) \} = {𝒥}_{S} \{ {\sum }_{m = 0}^{M} {α}_{m} {v ( t )}^{m} \} \\ = {α}_{0} δ + {α}_{1} V + {α}_{2} V ⊗ V + … + {α}_{M} \overbrace{V ⊗ V ⋯ ⊗ V}^{M}\end{matrix} \\ where : \\ δ ( x ) = \{ \begin{matrix}1 & x = 0 \\ 0 & else\end{matrix} \qquad ( 6 )$$

By making the following operator definition:

$${\prod }_{⊗}^{M} V = \overbrace{V ⊗ V ⋯ V}^{M}$$

$${\prod }_{⊗}^{M} V = V$$

$${\prod }_{⊗}^{0} V = δ$$

then (6) can be defined simply as:

$${𝔍}_{S} \{ i ( v ( t ) ) \} = {𝔍}_{S} \{ {\sum }_{m = 0}^{M} {α}_{m} {v ( t )}^{m} \} = {\sum }_{m = o}^{M} {α}_{m} {\prod }_{⊗}^{m} V \qquad ( 7 )$$

Similarly, by using the polynomial expansion of (5) for

$$\frac{ⅆ q ( v ( t ) )}{ⅆ t} ,$$

it can be shown that:

$$\begin{matrix}{𝔍}_{S} \{ \frac{ⅆ q ( v ( t ) )}{ⅆ t} \} = {𝔍}_{S} \{ \frac{ⅆ}{ⅆ t} ( {\sum }_{m = 0}^{M} {β}_{m} {v ( t )}^{m} ) \} \\ = {𝔍}_{S} \{ {\sum }_{m = 0}^{M} {β}_{m} \frac{ⅆ}{ⅆ t} ( {v ( t )}^{m} ) \} \\ = {𝔍}_{S} \{ {\sum }_{m = 0}^{M} {β}_{m} \frac{ⅆ v ( t )}{ⅆ t} ( {v ( t )}^{m - 1} ) \}\end{matrix} \qquad ( 8 )$$

It can also be shown that:

$${𝔍}_{S} \{ \frac{ⅆ v ( t )}{ⅆ t} \} = V Ω$$

$$where \text{:}$$

$$Ω = diag \{ - {jω}_{L} , … , {jω}_{L} \} ∈ {C}^{L \times L}$$

and ω_{L}=2πLf₀
Therefore, equation (8) can be written as:

$${𝔍}_{S} \{ \frac{ⅆ q ( v ( t ) )}{ⅆ t} \} = {\sum }_{m = 0}^{M} m {β}_{m} ( V Ω ) ⊗ {\prod }_{⊗}^{m - 1} V \qquad ( 9 )$$

Using the definitions of equations (7) and (9), the frequency domain representation of the general circuit node equation in (3) can be written as:

$${\sum }_{m = 0}^{M} {α}_{m} {\prod }_{⊗}^{m} V + {\sum }_{m = 0}^{M} m {β}_{m} ( V Ω ) ⊗ {\prod }_{⊗}^{m - 1} V + YV + U = 0 \qquad ( 10 )$$

where V, Y and U are Fourier series representations of v(t), y(t) and u(t), respectively. Equation (10), in which Y and U are known and V is unknown, provides an example of an ICE in that it is as simplified form of the general ICE equation of (1). The main operation in equation (10), notwithstanding the linear parts of the circuit, is the self-convolution of vector V. Therefore, the key to solving equation (10) is finding the inverse of the summation of these self-convolution equations. The main solver provided herein provides for the solution of these ICEs, although a preliminary description of a number of sub-algorithms is warranted.
Linear Convolution and Deconvolution

The ICE solver algorithm makes use of several sub-algorithms, including various self-convolution sub-algorithms and inverse self-convolution algorithms. As a result, an explanation of the ICE solver method would benefit from a preliminary discussion of these sub-algorithms and associated mathematical definitions. First, the linear convolution of two vectors is defined, along with the associated linear deconvolution solution. For given vectors X=[X(1) X(2) . . . X(L)] and Y=[Y(1) Y(2) . . . Y(L)], where X, YεC the convolution of these two vectors Z=X\textcircled{x}Y is defined as follows:

$$Z ( i ) = {\sum }_{k = 1}^{i} X ( i - k + 1 ) Y ( k ) , i ∈ [ 1 , L ] \\ where Z = [ Z ( 1 ) Z ( 2 ) … Z ( L ) ] . \qquad ( 11 )$$

The associated deconvolution sub-algorithm solves for a vector X=[X() X(2) X(L)], that satisfies Z=X\textcircled{x}Y, where Y=[Y(1) Y(2) . . . Y(L)] and Z =[Z(1) Z(2) ... Z(L)], and where Y and ZεC^{1×M}. Based on the above definition of the linear convolution of two vectors, it can be shown that vector X is defined as follows:

$$X ( i ) = \frac{1}{Y ( 1 )} \{ Z ( i ) - {\sum }_{k = 1}^{i - 1} X ( i - k ) Y ( k + 1 ) \} \qquad ( 12 )$$

Self-Convolution Algorithms

Self-convolution and related inverse self-convolution sub-algorithms are defined in view of the above linear convolution and deconvolution definitions. In each of the following sub-algorithms, Y=[Y(1) Y(2) . . . Y(L)] is known and X=[X(1) X(2) . . . X(L)] is unknown. These inverse self-convolution sub-algorithms permit a solution to following set of convolution equations:
Y=Σπ_{\textcircled{x}}^{j} X
The solution to this set of equations can be found iteratively.

Examining the second order self-convolution product, the first product term is:
Y=π_{\textcircled{x}}² X=X\textcircled{x}X
where for a vector Y of length 3 the expanded equation becomes:

$$[ \begin{matrix}Y ( 1 ) \\ Y ( 2 ) \\ Y ( 3 )\end{matrix} ] = [ \begin{matrix}X ( 1 ) & 0 & 0 \\ X ( 2 ) & X ( 1 ) & 0 \\ X ( 3 ) & X ( 2 ) & X ( 1 )\end{matrix} ] [ \begin{matrix}X ( 1 ) \\ X ( 2 ) \\ X ( 3 )\end{matrix} ] = [ \begin{matrix}{X ( 1 )}^{2} \\ 2 X ( 1 ) X ( 2 ) \\ 2 X ( 1 ) X ( 3 ) + {X ( 2 )}^{2}\end{matrix} ]$$

Based upon the above representation, Y(i) can be defined as follows:
Y(i)=2X(1)X(i)+[X(i−1)X(i−2) . . . X(2)][X(2) . . . X(i−2)X(i−1)]^{T}
In addition, by defining the function H2 as:
H2(X(1:i−1))=[X(i−1)X(i−2) . . . X(2)][X(2) . . . X(i−2)X(i−1)]^{T}
it follows that:
Y(i)=2X(1)X(i)+H2(X(1:i−1))
Therefore, if X(i) is unknown, then:

$$X ( i ) = \frac{Y ( i ) - H 2 ( X ( 1 \text{:} i - 1 ) )}{2 X ( 1 )}$$

For a third order self-convolution product, the product of interest is:

$$Y = {\prod }_{⊗}^{3} X = X ⊗ X ⊗ X$$

$$where : Y ( 1 ) = {X ( 1 )}^{3}$$

$$Y ( 2 ) = 3 {X ( 1 )}^{2} X ( 2 )$$

$$⋮$$

$$\begin{matrix}Y ( i ) = 3 {X ( 1 )}^{2} X ( i ) + 2 X ( 1 ) H 2 ( X ( 1 \text{:} i - 1 ) ) + \\ [ X ( i - 2 ) ⋯ X ( 1 ) ] [ \begin{matrix}H 2 ( X ( 1 \text{:} 2 ) ) \\ ⋮ \\ H 2 ( X ( 1 \text{:} i - 1 ) )\end{matrix} ]\end{matrix}$$

Therefore, it follows that:

$$X ( i ) = \frac{\begin{matrix}Y ( i ) - 2 X ( 1 ) H 2 ( X ( 1 \text{:} i - 1 ) ) - \\ [ X ( i - 2 ) ⋯ X ( 1 ) ] [ \begin{matrix}H 2 ( X ( 1 \text{:} 2 ) ) \\ ⋮ \\ H 2 ( X ( 1 \text{:} i - 1 ) )\end{matrix} ]\end{matrix}}{3 {X ( 1 )}^{2}}$$

Similarly, for a forth order cascade self-convolution product the term is:

$$Y = {\prod }_{⊗}^{4} X = X ⊗ X ⊗ X ⊗ X$$

$$where : Y ( 1 ) = {X ( 1 )}^{4}$$

$$Y ( 2 ) = 4 {X ( 1 )}^{3} X ( 2 )$$

$$\begin{matrix}Y ( 2 ) = Y ( 3 ) = 4 {X ( 1 )}^{3} X ( 3 ) + 3 {X ( 1 )}^{2} + X ( 1 ) [ X ( 2 ) X ( 1 ) ] \\ [ \begin{matrix}X ( 2 ) & X ( 1 ) \\ 0 & X ( 2 )\end{matrix} ] [ \begin{matrix}X ( 1 ) \\ X ( 2 )\end{matrix} ] \\ ⋮\end{matrix}$$

$$\begin{matrix}Y ( i ) = 4 {X ( 1 )}^{3} X ( i ) + 3 {X ( 1 )}^{2} [ X ( i - 1 ) ⋯ X ( 2 ) ] [ \begin{matrix}X ( 2 ) \\ ⋮ \\ X ( i - 1 )\end{matrix} ] + \\ [ X ( i - 2 ) ⋯ X ( 1 ) ] [ \begin{matrix}H 3 ( X ( 1 \text{:} 2 ) ) \\ ⋮ \\ H 3 ( X ( 1 \text{:} i - 1 ) )\end{matrix} ]\end{matrix}$$

and where the function H3 is defined as:

$$H 3 ( X ( 1 \text{:} i - 1 ) ) = [ X ( i - 1 ) ⋯ X ( 1 ) ] \cdot A \cdot [ \begin{matrix}X ( 1 ) \\ ⋮ \\ X ( i - 1 ) )\end{matrix} ] \\ where A is the matrix : \\ A = [ \begin{matrix}X ( 2 ) & X ( 1 ) & 0 & 0 & ⋯ & 0 \\ X ( 3 ) & X ( 2 ) & X ( 1 ) & 0 & ⋯ & 0 \\ ⋮ & ⋮ & ⋮ & ⋮ & ⋰ & ⋮ \\ X ( L ) & X ( L - 1 ) & X ( L - 2 ) & X ( L - 3 ) & ⋯ & X ( 1 ) \\ 0 & X ( L ) & X ( L - 1 ) & X ( L - 2 ) & ⋯ & X ( 2 )\end{matrix} ] \qquad ( 13 )$$

The value of X(i) is then given as:

$$X ( i ) = \frac{\begin{matrix}Y ( i ) - 3 {X ( 1 )}^{2} [ X ( i - 1 ) ⋯ X ( 2 ) ] [ \begin{matrix}X ( 2 ) \\ ⋮ \\ X ( i - 1 )\end{matrix} ] - \\ [ X ( i - 2 ) ⋯ X ( 1 ) ] [ \begin{matrix}H 3 ( X ( 1 \text{:} 2 ) ) \\ ⋮ \\ H 3 ( X ( 1 \text{:} i - 1 ) )\end{matrix} ]\end{matrix}}{4 {X ( 1 )}^{3}}$$

The expansions and solutions for higher order self-convolution equations may be found in a similar fashion to those for the second-, third- and fourth-order self-convolution equations.

Inverse Convolution Algorithms

Building on the self-convolution sub-algorithms noted above, inverse self-convolution sub-algorithms are developed which provide solutions for a special case of ICEs, specifically linear combinations of self-convolution terms. Again, the solution for lower order self-convolution equations is developed to illustrate the overall method for solving linear combinations of ICEs. In the following sub-algorithms, Y=[Y(1) Y(2) . . . Y(L)] is known and X=[X(1) X(2) . . . X(L)] is unknown. The first self-convolution sub-algorithm is developed with respect to the second-order self-convolution equation defined as:

$$Y = X ⊗ X \\ Y ( i ) = {\sum }_{k = 1}^{i} X ( i - k + 1 ) X ( k ) , i ∈ [ 1 , L ] \qquad ( 14 )$$

For ease of reference, equation (14) can be represented as follows:
X=π_{\textcircled{x}}_{^{−1}}² Y
It follows from the above definition of Y(i) that:

$$X ( 1 ) = {( Y ( 1 ) )}^{\frac{1}{2 i - 1}} \\ X ( 2 ) = \frac{Y ( 2 )}{2 X ( 1 )} \\ X ( i ) = \frac{1}{2 x ( 1 )} \{ Y ( i ) - {\sum }_{k = 1}^{i - 1} X ( i - k ) X ( k + 1 ) \} , where i > 2 \qquad ( 15 )$$

The second self-convolution sub-algorithm is developed for a third-order self-convolution equation defined as:
Y=X\textcircled{x}X\textcircled{x}X=π_{\textcircled{x}}³X
or equivalently:
X=π_{\textcircled{x}}_{^{−1}}³Y
where the operator \textcircled{x} is the convolution as defined in (11). It follows that:

$$X ( 1 ) = {( Y ( 1 ) )}^{\frac{1}{3}} \\ X ( 2 ) = \frac{Y ( 2 )}{3 {X ( 1 )}^{2}} \\ \begin{matrix}X ( i ) = \frac{1}{ 3 {( x ( 1 ) )}^{2}} \\ \{ Y ( i ) - [ X ( i - 1 ) X ( i - 2 ) ⋯ X ( 1 ) ] \cdot A \cdot \\ [ X ( 1 ) X ( 2 ) ⋯ X ( i - 1 ) ] \}\end{matrix} \qquad ( 16 )$$

where A is the matrix as defined in (13).

The more general self convolution algorithm provides the solution for the following equation:

$$Y = \overbrace{X ⊗ X ⋯ ⊗ X}^{K} = {\prod }_{⊗}^{K} X , K = {2}^{J} J ∈ N$$

$$or equivalently : \\ X = {\prod }_{{⊗}^{- 1}}^{K} Y , K = {2}^{J} J ∈ N$$

where the operator \textcircled{x} is the convolution as defined in (11). Where J>1, solving for X can be achieved through the following process:
Step 1: Use the sub-algorithm of (14) to find Zᵢ=[Z₁(1) Z₁(2) . . . Z₁(M)] that satisfies the following: Y=Z₁\textcircled{x}Z₁
Step 2: If J<1, then X=Z₁; otherwise, use the sub-algorithm of (14) to find Z₂=[Z₂(1) Z₂(2) . . . Z₂(L)] that satisfies the following: Z₁=Z₂\textcircled{x}Z₂
Step 3: If J<2, then X=Z₂; otherwise, use the sub-algorithm of (14) to find Z₃=[Z₃(1) Z₃(2) . . . Z₃(L)] that satisfies the following: Z₂=Z₃\textcircled{x}Z₃
. . .
Step i: J is equal to i−1; use the sub-algorithm of (14) to find Zᵢ=[Zᵢ(1) Zᵢ(2) . . . Zᵢ(L)] that satisfies the following: Zᵢ₋₁=Zᵢ\textcircled{x}Zᵢ
Inverse Convolution Equation Solver Algorithms

The solver algorithm for ICEs is illustrated first with respect to a general third order ICE. Given U=[U₁ U₂ . . . U_{L}]εC^{1×L}, the third-order ICE solver algorithm finds V=[V₁ V₂ . . . V_{L}] which satisfies the following:

$$U = {\sum }_{r = 1}^{3} {α}_{r} {\prod }_{⊗}^{r} V = {α}_{1} V + {α}_{2} {\prod }_{⊗}^{2} V + {α}_{3} {\prod }_{⊗}^{3} V \qquad ( 17 )$$

The solution for equation (17) is developed as follows. V₁ is found by calculating the roots of the following polynomial:

$${\sum }_{r = 1}^{3} {α}_{r} {V}_{r} - {U}_{1} = 0 \qquad ( 18 )$$

in which the αᵣ variables are known system model parameters, U₁ is a known value, and V is unknown. Since equation (17) is a third-order polynomial, there are three roots that satisfy the equation. If there are physical boundaries defined in the problem statement, some of the possible solutions will be eliminated either at the first step or in subsequent steps. Therefore, the value of V₁ and the remaining values of V are given as follows:

$${V}_{1} = {min}_{{V}_{1}} \{ {a}_{1} {V}_{1} + {a}_{2} {V}_{1}^{2} + {a}_{3} {V}_{1}^{3} - U = 0 \} \\ {V}_{2} = \frac{{U}_{2}}{{α}_{1} + 2 {α}_{2} {V}_{1} + 3 {α}_{3} {V}_{1}^{2}} \\ ⋮ \\ {V}_{L} = \frac{{U}_{L} - {α}_{2} {A}_{2 \text{:} L - 1} - 3 {α}_{3} {V}_{1} {A}_{2 \text{:} L - 1} - {α}_{3} {\sum }_{i = 2}^{L - 2} {V}_{i {A}_{2 \text{:} L - i}}}{{α}_{1} + 2 {α}_{2} {V}_{1} + 3 {α}_{3} {V}_{1}^{2}} \\ where \\ {A}_{m \text{:} n} = {\sum }_{i = m}^{n} {V}_{n - i + 1} {V}_{i} \\ and where \\ {V}_{1} = {min}_{{V}_{1}} \{ {a}_{1} {V}_{1} + {a}_{2} {V}_{1}^{2} + {a}_{3} {V}_{1}^{3} - {U}_{1} = 0 \} \qquad ( 19 )$$

indicates that V₁ is equal to the minimum value of V₁ that satisfies the equation
a₁V₁+a₂V₁²+a₃V₁³−U₁=0 (20)

For systems in which higher-order non-linearities are present, the solver algorithm for general N-order ICEs is as follows. Again, Given U=[U₁ U₂ . . . U_{L}]εC^{1×l}, the general ICE solver algorithm finds V=[V₁ V₂ . . . V_{L}] which satisfies the following:

$$U = {\sum }_{r = 1}^{N} {α}_{r} {\prod }_{⊗}^{r} V = {α}_{1} V + {α}_{2} {\prod }_{⊗}^{2} V + {α}_{3} {\prod }_{⊗}^{3} V + … + {α}_{N} {\prod }_{⊗}^{N} V \qquad ( 21 )$$

As with the solution to the third-order ICE, V₁ is found by calculating the roots of the following polynomial:

$${\sum }_{r = 1}^{N} {α}_{r} {V}_{r} - {U}_{1} = 0$$

in which the αᵣ variables are known system model parameters, U₁ is a known value, and V is unknown. For the general ICE of equation (21) the value of V₁ and the remaining values of V are given as follows:

$$\begin{matrix}{V}_{1} = {min}_{{V}_{1}} \{ {a}_{1} {V}_{1} + {a}_{2} {V}_{1}^{2} + ⋯ + {a}_{N} {V}_{1}^{3} - {U}_{1} = 0 \} \\ {V}_{2} = \frac{{U}_{2}}{{α}_{1} + 2 {α}_{2} {V}_{1} + 3 {α}_{3} {V}_{1}^{2} + ⋯ + N {α}_{N} {V}_{1}^{N - 1}} \\ ⋮ & \\ \begin{matrix}{V}_{L} = \frac{{U}_{L} - {α}_{2} {A}_{2 \text{:} L - 1} - 3 {α}_{3} {V}_{1} {A}_{2 \text{:} L - 1} - {α}_{3} {\sum }_{i = 2}^{L - 2} {V}_{i {A}_{2 \text{:} L - i}}}{{α}_{1} + 2 {α}_{2} {V}_{1} + 3 {α}_{3} {V}_{1}^{2} + ⋯ + N {α}_{N} {V}_{1}^{N - 1}} - \\ \frac{{α}_{N} \{ ( N - 1 ) {V}_{1}^{( N - 2 )} {A}_{2 \text{:} L - 1} + ( N - 2 ) {V}_{1}^{( N - 3 )} {\sum }_{i = 1}^{L - 2} {V}_{i } {A}_{2 \text{:} L - i} +}{{α}_{1} + 2 {α}_{2} {V}_{1} + 3 {α}_{3} {V}_{1}^{2} + ⋯ + N {α}_{N} {V}_{1}^{N - 1}} \\ \frac{… + {\sum }_{m = 1}^{L - 3} {V}_{m} {\sum }_{k - 1}^{L - m - 2} {V}_{k} … {\sum }_{m = 1}^{L - 3} {V}_{j} {\sum }_{k - 1}^{L - m - 2} {V}_{i} {A}_{2 \text{:} L - m - k - i - j - …} \}}{{α}_{1} + 2 {α}_{2} {V}_{1} + 3 {α}_{3} {V}_{1}^{2} + ⋯ + N {α}_{N} {V}_{1}^{N - 1}}\end{matrix} & ( 22 )\end{matrix}$$

where Aₘₙ is as defined in equation (20), and where:

$${V}_{1} = {min}_{{V}_{1}} \{ {α}_{1} {V}_{1} + {α}_{2} {V}_{1}^{2} + ⋯ + {α}_{N} {V}_{1}^{N} - {U}_{1} = 0 \}$$

indicates that V₁ is equal to the minimum value of V₁ that satisfies the equation
α₁V₁+α₂V₁²+ . . . +α_{N}V₁^{N}−U₁=0

Therefore, by framing an equation as a linear combination of ICEs, as in the general form of equation (21), the equation can be solved by applying the solutions set forth in (22). This solver can be applied regardless of the degree of non-linearity exhibited by the system. In addition, the solution set forth in (22) is non-iterative, and therefore any problems of convergence are avoided.

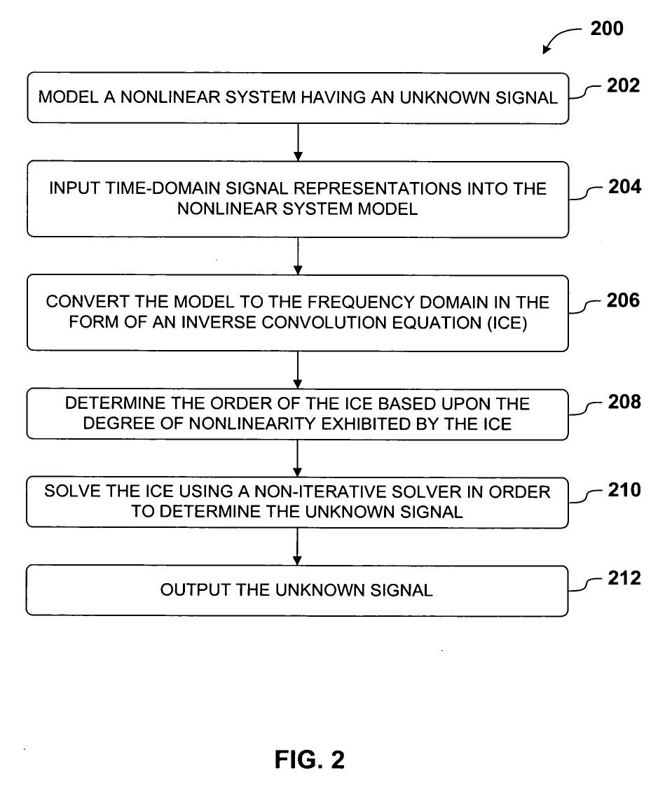

FIG. 2 illustrates a method 200 for simulating a non-linear system using the non-iterative solver algorithm of (22). First, at 202 the nonlinear system is modeled and parameters which describe the nonlinear system are generated. Modeling the system may involve determining mathematical parameters associated with each of the individual system components and then determining the mathematical relationships between these system components. For an electrical circuit, modeling system may first involve determining the electrical parameters (such as inductance, resistance, capacitance, transconductance, or other electrical parameters) associated with individual devices (such as resistors, capacitors, inductors, diodes, transistors, or other circuit devices) or composite electrical components (such as amplifiers, transducers, current generators, or other composite electrical components). A circuit model based on these electrical parameters may then be generated based on the arrangement of the individual devices and composite electrical components in the circuit.

Next, at 204 the system model can be represented as time-varying function in terms of known input and output signals, and an unknown signal. This may involve determining the respective forms of various input and output signals and then inputting these signals into the system model. For an electrical circuit, certain signals may be known to represent sinusoidal or pulse functions; the time domain functions representing these signals can be input into the system model to generate a time domain representation of the nonlinear system.

At 206, the time domain representation is converted into the frequency domain by substituting the time domain multiplications with cascaded convolutions in the frequency domain, thereby creating representing the system as an ICE. The steps of representing the system in the time domain and converting to the frequency domain are optional, and a known frequency model of the system comprising cascaded convolutions may be generated without first generating the time-varying representation in an intermediate step. In the latter case, the signals may be represented in the frequency domain and input into the system model to generate the ICE.

Next, at 208 the convolution order of the ICE is determined based upon the degree of nonlinearity in the system. At 210 the unknown signal is solved for using a non-iterative solver, such as the solver algorithm of (22). The general solver algorithm of (22) is adapted to the ICE order of the frequency model, and the specific solver algorithm is applied to the frequency representation in order to solve for the unknown signal. Finally, at 212 the unknown signal, now having been determined through application of the specific solver algorithm, is output and can be used to complete simulation and analysis of the circuit.

FIG. 3 illustrates a method 300 for simulating a non-linear system using the non-iterative solver algorithm of (22) that does not require generating a time domain representation of the system. First, at 302 the nonlinear system is modeled and parameters which describe the nonlinear system are generated. Next, at 304 the system is represented as an ICE comprising a series of cascaded self-convolutions. Then, at 306 the order of the ICE is determined based upon the degree of nonlinearity (self-convolution) in the system. At 307 the general solver algorithm of (22) is adapted to the order of the ICE, and the specific solver algorithm is applied to the frequency representation in order to solve for the unknown signal. Finally, at 310 the unknown signal, now having been determined through application of the specific solver algorithm and without the performance of any calculation or simulation in the time domain, is output and can be used to complete simulation and analysis of the circuit.

Cross-Referenced Coordinates Technique

In another embodiment of the present invention, the general nonlinear solver method may be combined with the “cross-referenced coordinates” (CRC) frequency technique (equivalent to the “compressed vector-based” (CVB) frequency technique of U.S. application Ser. No. 10/535,616, which is incorporated in its entirety by reference herein) in order to achieve the combined benefits of assured convergence, high nonlinearity tolerance, and computational efficiency. In contrast with existing solutions, a combined CRC and ICE solver analysis does not require time domain simulation as part of a frequency domain analysis. As a result, for digitally modulated signals, simulations based on a combined CRC and ICE simulation is highly accurate and offers greater efficiency over existing simulation solutions.

The CRC technique is an extension of the baseband-equivalent (BBE) method, which permits the simplified analysis and simulation of systems but is limited in application to linear systems. The CRC technique expands BBE concepts to the nonlinear domain by defining multiple coordinates as references and re-structuring the frequency domain representation of the signals into a dense matrix instead of a sparse vector.

When applying the CRC technique, and with respect to circuit applications, the input signals are considered to be band-limited in the frequency domain. In addition to being a precondition, the degree to which a signal is band-limited also affects the computational efficiency of the CRC technique, with the efficiency of the technique increasing as the ratio of the bandwidth of the signal to the carrier frequency decreases. The application of CRC methods is illustrated with respect to example signals and circuits below.

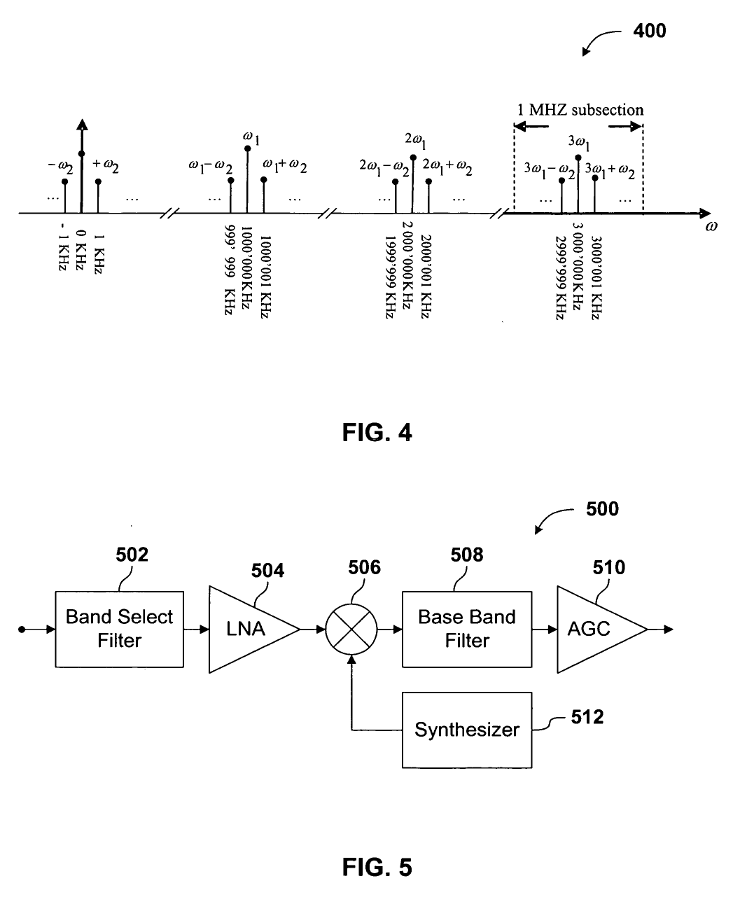

FIG. 4 illustrates a typical nonlinearly disturbed digitally modulated RF signal as an example of a band-limited input signal. The carrier frequency of the signal is 1 GHz, and its maximum bandwidth is 1 MHz. The ratio of the bandwidth of signal to the carrier frequency is 0.0001 (1 MHz/1 GHz). Generally, for signal processing applications, input signals that have such a small bandwidth-to-carrier frequency ratio are classified as sparse vectors.

FIG. 5 shows a simplified RF front end system 500 comprising a band select filter 502, an LNA 504, a mixer 506, a base-band filter 508, a synthesizer 512, and an auto gain controller 510. Due to nonlinearities characteristic of the LNA 504, the odd intermodulation products will fall back into the signal band and disturb the signal PSD. This disturbance results in an increased overall bit error rate. When this disturbed signal passes through the mixer 506, both the even intermodulation products and odd intermodulation products will affect the output signal. Furthermore, the RF leakage of the synthesizer 512 or linear oscillator will add to the total distortion by creating a DC offset. The CRC technique permits a user to track the effect of each of these nonlinearities, through the use of matrices containing signal data points, as further explained below.

A continuous time periodic signal v(t) can be represented by a summation of Fourier series components:

$$v ( t ) = {\sum }_{i = 0}^{N} {B}_{i} {ⅇ}^{- {jⅈω}_{x}} = {B}_{0} {ⅇ}^{0} + {B}_{1} {ⅇ}^{- {jω}_{x}} + {B}_{2} {ⅇ}^{- {j2ω}_{x}} + ⋯$$

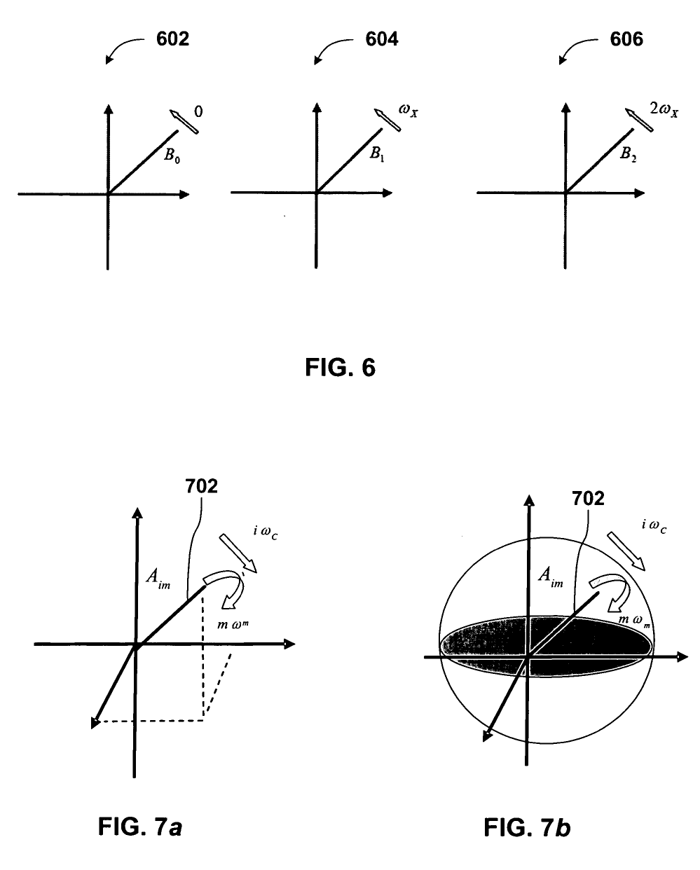

The geometrical representation of each of these components is illustrated in FIG. 6. Each component 602, 604, 606 is a rotating vector with amplitude Bᵢ and rotational speed iωₓ. In the CRC method, the same continuous time periodic signal v(t) is represented by:

$$v ( t ) = {\sum }_{i = 0}^{I} {\sum }_{m = - M}^{M} {A}_{im} {ⅇ}^{{jⅈω}_{C} t} {ⅇ}^{j m {ω}_{x} t} \qquad ( 23 )$$

The geometrical representation of each of the components of (23) is illustrated in FIGS. 7a and 7b. Each component of the CRC representation is a rotating vector 702 in the 3-dimensional space with amplitude Aᵢⱼ and rotational speeds iω_{C} and mωₘ.

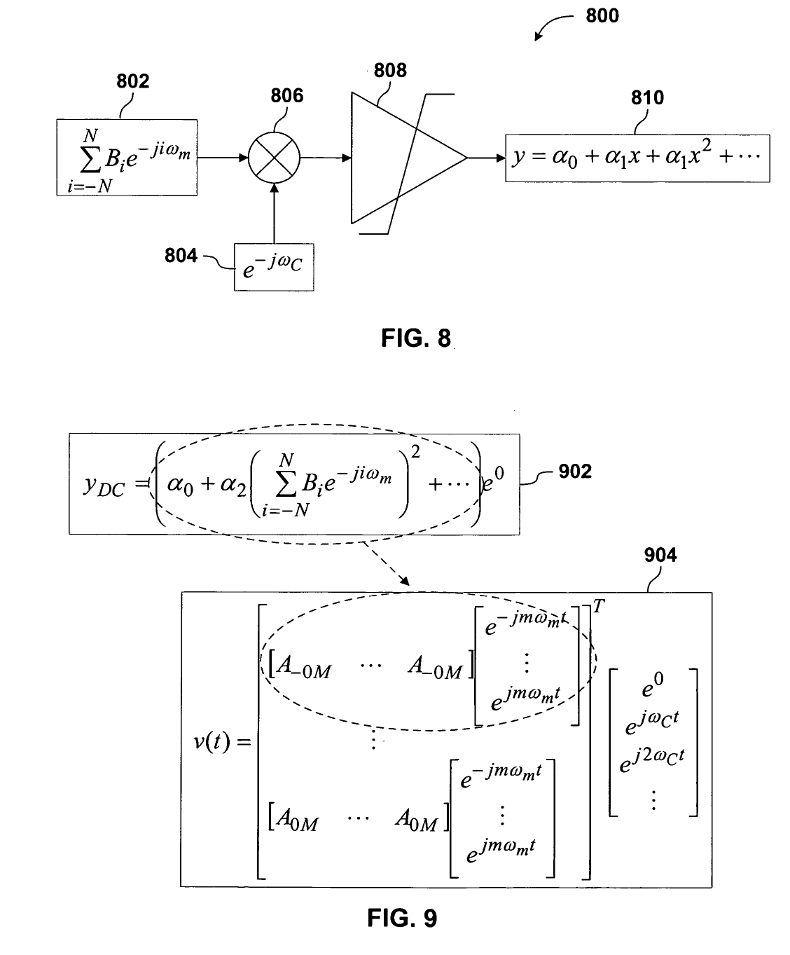

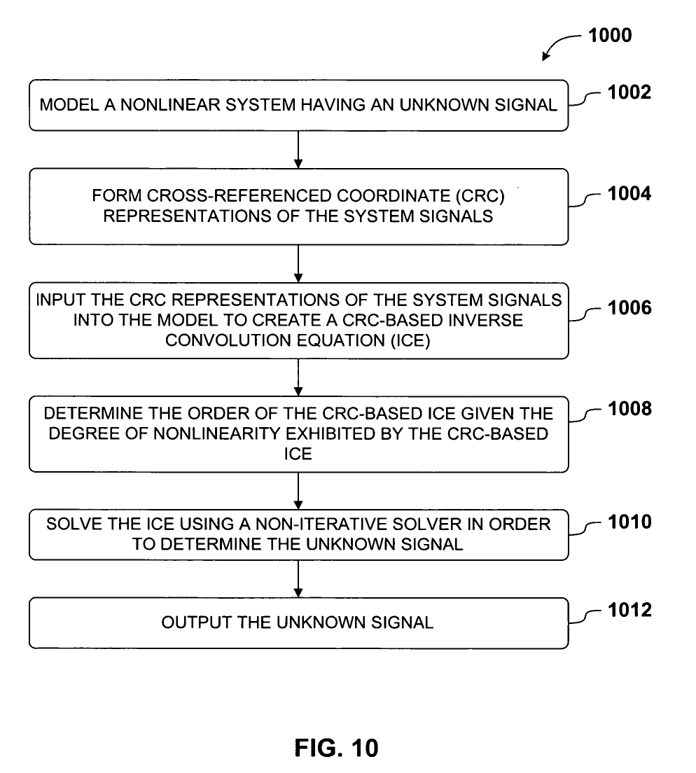

The matrix representation of a CRC signal is introduced through the following general example. FIG. 8 illustrates a nonlinear system 800. The input signal 802 is mixed with a carrier frequency signal 804 by the mixer 806. After processing by the filter 808, the output signal 810 can be written as a polynomial summation. The terms generated due to nonlinearity around the frequency bands are as follows:

$$around DC \text{:} {y}_{DC} = ( {α}_{0} + {{α}_{2} ( {\sum }_{i = - N}^{N} {B}_{i} {ⅇ}^{- {jⅈω}_{m}} )}^{2} + ⋯ ) {ⅇ}^{0}$$

$$around {ω}_{C} \text{:} {y}_{{ω}_{C}} = ( {α}_{1} ( {\sum }_{i = - N}^{N} {B}_{i} {ⅇ}^{- {jⅈω}_{m}} ) + {{α}_{1} ( {\sum }_{i = - N}^{N} {B}_{i} {ⅇ}^{- {jⅈω}_{m}} )}^{3} + ⋯ ) {ⅇ}^{- {jω}_{C}}$$

$$around 2 {ω}_{C} \text{:} {y}_{2 {ω}_{C}} = ( {{α}_{2} ( {\sum }_{i = - N}^{N} {B}_{i} {ⅇ}^{- {jⅈω}_{m}} )}^{2} + ⋯ ) {ⅇ}^{- {j2ω}_{C}}$$

$$⋮$$

In the CRC matrix representation of the signal, each of these components forms one row. For example, the components around DC form the first row of the CRC matrix representation of v(t), as shown below and as further illustrated in FIG. 9:

$$v ( t ) = {[ \begin{matrix}[ \begin{matrix}{A}_{- 0 M} & ⋯ & {A}_{- 0 M}\end{matrix} ] [ \begin{matrix}{ⅇ}^{- j M {ω}_{M} t} \\ ⋮ \\ {ⅇ}^{+ j M {ω}_{M} t}\end{matrix} ] \\ ⋮ \\ [ \begin{matrix}{A}_{0 M} & ⋯ & {A}_{0 M}\end{matrix} ] [ \begin{matrix}{ⅇ}^{- j M {ω}_{M} t} \\ ⋮ \\ {ⅇ}^{+ j M {ω}_{M} t}\end{matrix} ]\end{matrix} ]}^{T} [ \begin{matrix}{ⅇ}^{0} \\ {ⅇ}^{{jω}_{C} t} \\ {ⅇ}^{{j2ω}_{C} t} \\ ⋮\end{matrix} ]$$

In FIG. 9, the y term generated around DC 902 becomes the first row of the CRC matrix representation of v(t).

The representation of a signal in the CRC domain can further be illustrated through a series of specific examples using known signals. In the first example, the input signal is a sinusoidal waveform given by:

$${v}_{m} ( t ) = {A}_{m} cos {ω}_{m} t = \frac{{A}_{m}}{2} ( {ⅇ}^{{jω}_{m} t} + {ⅇ}^{- {jω}_{m} t} )$$

in which Aₘ is the constant amplitude and ωₘ is the frequency. The multiplication of the input signal vₘ with a carrier signal v_{C} will be:

$$\begin{matrix}{v}_{m} ( t ) {v}_{c} ( t ) = {v}_{mC} ( t ) = \frac{{A}_{m} {A}_{c}}{4} ( {ⅇ}^{j ( {ω}_{C} + {ω}_{m} ) t} + {ⅇ}^{- j ( {ω}_{C} + {ω}_{m} ) t} + \\ {ⅇ}^{j ( {ω}_{C} - {ω}_{m} ) t} + {ⅇ}^{- j ( {ω}_{C} - {ω}_{m} ) t} )\end{matrix}$$

$$where$$

$${v}_{C} ( t ) = {A}_{C} cos {ω}_{C} t = \frac{{A}_{C}}{2} ( {ⅇ}^{j {ω}_{C} t} + {ⅇ}^{- {jω}_{C} t} )$$

For ωₘ=1 rad/sec and ω_{C}=5 rad/sec, the Fourier series representation of vₘ(t)v_{C}(t) is the following:

$$\begin{matrix}\begin{matrix}{v}_{mC} ( t ) = \frac{{A}_{m} {A}_{c}}{4} ( {ⅇ}^{j ( 6 ) t} + {ⅇ}^{- j ( 6 ) t} + {ⅇ}^{j ( 4 ) t} + {ⅇ}^{- j ( 4 ) t} ) \\ {v}_{mC} ( t ) = \frac{{A}_{m} {A}_{c}}{4} [ 1 \; 0 \; 1 \; 0 \; 0 \; 0 \; 0 \; 0 \; 0 \; 1 \; 0 \; 1 ] \cdot {W}_{6}^{′} where\end{matrix} & \\ {W}_{n}^{′} = ⌊ {ⅇ}^{- j nt} {ⅇ}^{- j ( n - 1 ) t} … {ⅇ}^{0} … {ⅇ}^{j ( n - 1 ) t} {ⅇ}^{j nt} ⌋ & ( 24 )\end{matrix}$$

Alternatively, v_{mC}(t) can be represented by:

$${v}_{mC} ( t ) = \frac{{A}_{m} {A}_{c}}{4} {( [ \begin{matrix}1 & 1 \\ 1 & 1\end{matrix} ] [ \begin{matrix}{ⅇ}^{- j t} \\ {ⅇ}^{j t}\end{matrix} ] )}^{T} [ \begin{matrix}{ⅇ}^{- j6 t} \\ {ⅇ}^{j6 t}\end{matrix} ]$$

which corresponds to the CRC representation of V_{mC}:

$${V}_{{mC}_{CRC}} = [ \begin{matrix}1 & 1 \\ 1 & 1\end{matrix} ]$$

If v_{mC}(t) passes through a y=x³ nonlinear system, the output signal will become:

$$\begin{matrix}y ( t ) = {( {v}_{ mC} ( t ) )}^{3} \\ = \frac{ {( {A}_{ m} {A}_{ c} )}^{3}}{ 64} ( {ⅇ}^{- 12 j t} + 2 {ⅇ}^{- 10 j t} + {ⅇ}^{- 8 j t} + 3 + \\ 2 {ⅇ}^{ 2 j t} + {ⅇ}^{ 8 j t} + 2 {ⅇ}^{ 10 j t} + {ⅇ}^{ 12 j t} )\end{matrix}$$

The Fourier representation of y(t) is

$$y ( t ) = \frac{{( {A}_{m} {A}_{c} )}^{3}}{64} [ \begin{matrix}1 & 0 & 2 & 0 & 1 & 0 & 0 & 0 & 0 & 0 & 2 & 0 & 3 & 0 & 2 & 0 & 0 & 0 & 0 & 0 & 1 & 0 & 2 & 0 & 1\end{matrix} ] \cdot {W}_{12}^{′}$$

where W′₁₂ is as defined in (24).
Alternatively, y(t) can be represented as follows:

$$y ( t ) = {( [ \begin{matrix}0 & 1 & 2 \\ 1 & 0 & 0 \\ 2 & 3 & 2 \\ 0 & 0 & 1 \\ 2 & 1 & 0\end{matrix} ] [ \begin{matrix}{ⅇ}^{- 2 j t} \\ {ⅇ}^{0} \\ {ⅇ}^{2 j t}\end{matrix} ] )}^{T} [ \begin{matrix}{ⅇ}^{- 12 j t} \\ {ⅇ}^{- 6 j t} \\ {ⅇ}^{0} \\ {ⅇ}^{6 j t} \\ {ⅇ}^{12 j t}\end{matrix} ]$$

In this example, the CRC representation of y(t), Y_{CRC} is as follows:

$${Y}_{CRC} = [ \begin{matrix}0 & 1 & 2 \\ 1 & 0 & 0 \\ 2 & 3 & 2 \\ 0 & 0 & 1 \\ 2 & 1 & 0\end{matrix} ]$$

As can be deduced from this example, the size of the CRC representation of a signal is independent of the carrier frequency value. For instance, if ω_{C} is increased from 5 rad/sec to 50 rad/sec, the size of the Fourier series representation of y(t) increases from 25 to 201, while the size of Y_{CRC} stays the same.

In a more general sense, the signal x(t) with the following Fourier series approximation is considered:

$$\begin{matrix}x ( t ) ≅ {\sum }_{l = - L}^{L} {a}_{1} cos ( l {ω}_{0} t + {ψ}_{1} ) \\ e ( t ) = {\sum }_{l = - ∞}^{- L - 1} {a}_{l} cos ( l {ω}_{0} t + {ψ}_{1} ) + {\sum }_{l = L + 1}^{∞} {a}_{l} cos ( l {ω}_{0} t + {ψ}_{1} )\end{matrix} \qquad ( 25 )$$

where a₁, ω₀ and ψ₁ are time-invariant parameters. The value of e(t) represents the total truncation error. Alternatively, x(t) can be expanded as following:

$$\begin{matrix}x ( t ) ≅ {\sum }_{n = - N}^{N} {\sum }_{m = - M}^{M} {r}_{nm} cos ( n {ω}_{1} t + {θ}_{n} ) cos ( m {ω}_{2} t + {ϕ}_{nm} ) \\ e ( t ) = {\sum }_{n = - ∞}^{- N - 1} {\sum }_{m = - ∞}^{- M - 1} {r}_{nm} cos ( n {ω}_{1} t + {θ}_{n} ) cos ( n {ω}_{2} t + {ϕ}_{nm} ) + \\ {\sum }_{n = N + 1}^{∞} {\sum }_{m = M + 1}^{∞} {r}_{nm} ( cos ( n {ω}_{1} t + {θ}_{n} ) cos ( m {ω}_{2} t + {ϕ}_{nm} )\end{matrix} \qquad ( 26 )$$

where ω₁, ω₂, θₙ, φₙₘ and rₙₘ are time-invariant parameters. The Fourier series approximation in equation (25) is a special case of equation (26) in which N=0, θₙ=0, φₙₘ=ψ₁, rₙₘ=a₁ and M=L. Equation (25) is the CRC representation of the signal. The CRC base-band equivalent of the signal x(t) in equation (26) is the following:

$${x}_{CRC} ( t ) = {[ \begin{matrix}{x}_{0} ( t ) & {x}_{1} ( t ) & ⋯ & {x}_{N} ( t )\end{matrix} ]}^{T}$$

$${x}_{n} ( t ) = {\sum }_{m = - M}^{M} {r}_{n m} cos ( m {ω}_{2} t + {ϕ}_{n m} )$$

$${X}_{CRC} ( f ) = F \{ {x}_{CRC} ( t ) \} = [ \begin{matrix}{X}_{0} ( f ) \\ ⋮ \\ {X}_{N} ( f )\end{matrix} ]$$

Cross-Referenced Coordinate Convolution

Because of the unique signal representation of the CRC technique, mathematical operators need to be defined due to unique behavior. The convolution of two vectors as previously defined in (11) must be modified as follows. Given the following matrices:

$$X = [ \begin{matrix}X ( 1 , \text{:} ) \\ X ( 2 , \text{:} ) \\ ⋮ \\ X ( N , \text{:} )\end{matrix} ] and Y = [ \begin{matrix}Y ( 1 , \text{:} ) \\ Y ( 2 , \text{:} ) \\ ⋮ \\ Y ( N , \text{:} )\end{matrix} ] where X , Y ∈ {C}^{N \times M} \qquad ( 27 )$$

the CRC convolution of X and Y is defined as follows:

$$Z = [ \begin{matrix}Z ( 1 , \text{:} ) \\ Z ( 2 , \text{:} ) \\ ⋮ \\ Z ( 3 , \text{:} )\end{matrix} ] = X {⊗}_{CRC} Y , Z ∈ {C}^{N \times M} \\ Z ( i , \text{:} ) = {\sum }_{k = 1}^{i} X ( i - k + 1 \text{,} : ) ⊗ Y ( k , \text{:} ) , i ∈ [ 1 , N ] \qquad ( 28 )$$

where \textcircled{x} is the convolution as it is defined in (11).

The CRC equivalents of linear time invariant (LTI) systems are straightforward. The input-output relationships of a general LTI block are:

$$y ( t ) = {\int }_{- ∞}^{∞} h ( τ ) x ( t - τ ) ⅆ τ$$

Y(f)=H(f)X(f)
where H(f) is the Fourier transform of the impulse response h(t) of the LTI block. The CRC equivalent representation of the LTI block in the frequency domain (29) is:

$${Y}_{CRC} ( f ) = {H}_{CRC} ( f ) \times {X}_{CRC} ( f ) \\ {H}_{CRC} ( f ) = {[ {H}_{0} ( f ) ⋯ {H}_{N} ( f ) ]}^{T} \\ {H}_{i} ( f ) = H ( f + ifc ) \cdot [ u ( f + \frac{B}{2} - ) - u ( f - \frac{B}{2} ) ] , i ∈ [ 0 , N ] \qquad ( 30 )$$

where f_{C} is the main system frequency (carrier frequency for electrical circuits) and B is the bandwidth of interest.

In order to achieve the frequency domain CRC base-band equivalent of nonlinear systems, the ICE representation of the circuit is mapped into the CRC domain. The transformation and associate solver algorithms are described below.

CRC-Based Inverse Convolution Equations

An inverse convolution equation (ICE) in the CRC domain, or CRC-based ICE is defined as:

$$Y = {\sum }_{i = 0}^{I} {\sum }_{j = 0}^{J} {α}_{ij} {\prod }_{\begin{matrix}⊗ \\ CRC\end{matrix}}^{j} ( X * A ) \\ where \text{:} \\ {\prod }_{\begin{matrix}⊗ \\ CRC\end{matrix}}^{j} X = \overbrace{X {⊗}_{CRC} X ⋯ {⊗}_{CRC} X}^{j} \qquad ( 31 )$$

and where Y is a known matrix, X is the matrix of state variables in CRC format, A is a matrix of the same dimensions as X, and α=[αᵢⱼ] is a known matrix comprising known system model parameters. The value of J defines the order of the CRC-based ICE, and “*” is the array multiplication operator of the two matrices.

As an example of CRC based ICEs, the typical nonlinear analog circuit in equation (3) and illustrated in FIG. 1 is considered. The equivalent CRC domain frequency representation of equation (3) is:

$$\begin{matrix}{\sum }_{m = 0}^{M} {α}_{m} {\prod }_{\begin{matrix}⊗ \\ CRC\end{matrix}}^{m} {V}_{CRC} + {\sum }_{m = 0}^{M} {β}_{m} {\prod }_{\begin{matrix}⊗ \\ CRC\end{matrix}}^{m} ( {V}_{CRC} * {Ω}_{CRC} ) + \\ {Y}_{CRC} {V}_{CRC} + {U}_{CRC} = 0 \\ where \text{:} & ( 32 ) \\ {Ω}_{CRC} = [ \begin{matrix}- jn {ω}_{1} - jm {ω}_{2} & ⋯ & - jn {ω}_{1} + jm {ω}_{2} \\ ⋮ & 0 & ⋮ \\ - jn {ω}_{1} - jm {ω}_{2} & ⋯ & - jn {ω}_{1} + jm {ω}_{2}\end{matrix} ] & ( 33 )\end{matrix}$$

In general, a memoryless system in the CRC domain can be represented by:

$$U = {\sum }_{r = 1}^{R} {α}_{r} {\prod }_{\begin{matrix}⊗ \\ CRC\end{matrix}}^{r} V$$

$$or$$

$$U = {α}_{1} V + {α}_{2} V {⊗}_{CRC} V + {α}_{2} V {⊗}_{CRC} V {⊗}_{CRC} V + …$$

As above, the solver provided herein for CRC-based ICEs is best described by first presenting a number of preliminary sub-algorithms. For the following sub-algorithms, the following matrix definitions are utilized:

$$U = [ \begin{matrix}U ( 1 , \text{:} ) \\ U ( 2 , \text{:} ) \\ ⋮ \\ U ( L , \text{:} )\end{matrix} ] and V = [ \begin{matrix}V ( 1 , \text{:} ) \\ V ( 2 , \text{:} ) \\ ⋮ \\ V ( L , \text{:} )\end{matrix} ]$$

where U is known and V is unknown. A solution is first provided to the second order CRC-based ICE:

$$U = V {⊗}_{CRC} V$$

The solution is as follows:

$$V ( 1 , \text{:} ) = {\prod }_{{⊗}^{- 1}}^{2} ( U ( 1 , \text{:} ) )$$

$$V ( 2 , \text{:} ) = κ ( 2 V ( 1 , \text{:} ) , U ( 2 , \text{:} ) )$$

$$⋮$$

$$V ( i , \text{:} ) = κ ( 2 V ( 1 , \text{:} ) , U ( i , \text{:} ) - H2\_CRC ( V ) )$$

where κ is a deconvolution operator that denotes the deconvolution of two input vectors; for example, κ(2V(1,:), U(2,:)) is the vector that represents the deconvolution of vectors 2V(1,:) and U(2,:). H2_CRC(V) is calculated through the following:
H(i,:)=V(R−i+2,:)\textcircled{x}V(i,:) ∀iε[2,R]
H2_{—}CRC(1,j)=Σᵢ₌₁^{R}H(i,j) ∀jε[1, C]

For a third-order CRC-based ICE:

$$U = V {⊗}_{CRC} V {⊗}_{CRC} V = {\prod }_{{⊗}_{CRC}}^{3} V$$

The solution is as follows:

$$X ( 1 , \text{:} ) = {\prod }_{{⊗}^{- 1}}^{3} ( Y ( 1 , \text{:} ) ) \\ X ( 2 , \text{:} ) = κ ( 3 X ( 1 , \text{:} ) ⊗ X ( 1 , \text{:} ) , Y ( 2 , \text{:} ) ) \\ ⋮ \\ X ( i , \text{:} ) = κ ( 3 X ( 1 , \text{:} ) ⊗ X ( 1 , \text{:} ) , Y ( i , \text{:} ) - H3\_CRC ( X ) ) \qquad ( 34 )$$

CRC-Based Inverse Convolution Equation Solver Algorithms

The solver algorithm for CRC-based ICEs is illustrated first with respect to a general third order CRC-based ICE. For the following solver algorithms, the following matrix definitions are utilized:

$$U = [ \begin{matrix}U ( 1 , \text{:} ) \\ U ( 2 , \text{:} ) \\ ⋮ \\ U ( N , \text{:} )\end{matrix} ] and V = [ \begin{matrix}V ( 1 , \text{:} ) \\ V ( 2 , \text{:} ) \\ ⋮ \\ V ( N , \text{:} )\end{matrix} ]$$

where U is known and V is unknown. The solver algorithm for CRC-based ICEs provides the solution for an equation of the general form:

$$U = {α}_{1} V + {α}_{2} V {⊗}_{CRC} V + {α}_{2} V {⊗}_{CRC} V {⊗}_{CRC} V + … = {\sum }_{j = 1}^{J} {α}_{j} {{\prod }^{j}}_{{⊗}_{CRC}} V \qquad ( 35 )$$

where J is the order of the CRC-based ICE.

The solver algorithm for CRC-based ICEs is illustrated first with respect to a general third order CRC-based ICE. For the equation of (35) in which J=3, the solution is as computed through the following process:
Step 1: In order to calculate the V(1,:), the first row of matrix V, the following ICE must be solved:

$$\begin{matrix}U ( 1 , : ) = {α}_{ 1} V ( 1 , : ) + {α}_{ 2} V ( 1 , : ) {⊗}_{CRC} V ( 1 , : ) + \\ {α}_{ 2} V ( 1 , : ) {⊗}_{CRC} V ( 1 : ) {⊗}_{CRC} V ( 1 : )\end{matrix}$$

Step 2: V(2,:) is the deconvolution of the following known vectors, which can be solved with reference to equation (12):

$$\begin{matrix}Step L \text{:} \\ V ( L , \text{:} ) = κ \{ \begin{matrix}{α}_{1} + 2 {α}_{2} V ( 1 , \text{:} ) + 3 {α}_{3} V ( 1 , \text{:} ) ⊗ V ( 1 , \text{:} ) , \\ U ( L , : ) - {α}_{2} {A}_{CRC 2 : L - 1} - 3 {α}_{3} V ( 1 , : ) ⊗ \\ {A}_{CRC 2 : L - 1} - {α}_{3} {\sum }_{i = 2}^{L - 2} V ( i , : ) ⊗ {A}_{CRC 2 : L - i}\end{matrix} \} \\ where & \\ {A}_{CRCr : s} = {\sum }_{i = r}^{s} V ( s - i + 1 , \text{:} ) ⊗ V ( i , \text{:} ) & ( 36 )\end{matrix}$$

For systems in which higher-order nonlinearities are present, the solver algorithm for general N-order CRC-based ICEs is as follows:
Step 1: In order to calculate the V(1,:), the first row of matrix V, the following ICE must be solved:

$$V ( 1 , \text{:} ) = {α}_{1} V ( 1 , \text{:} ) + {α}_{2} V ( 1 , \text{:} ) {⊗}_{CRC} V ( 1 , \text{:} ) + {α}_{2} V ( 1 , \text{:} ) {⊗}_{CRC} V ( 1 , \text{:} ) {⊗}_{CRC} V ( 1 , \text{:} ) + ⋯ + {\prod }_{⊗}^{N} V ( 1 , \text{:} )$$

As a result, V(1,:) can be solved using the solution developed in (22)
Step 2: V(2,:) is the deconvolution of the following known vectors:
V(2,:)=κ{α₁+2α₂V(1,:)+3α₃V(1,:)\textcircled{x}V(1,:)+ . . . +Nα_{N}π_{\textcircled{x}}^{N-1},U(2,:)}
. . .

$$Step L \text{:}$$

$$\begin{matrix}V ( 2 , \text{:} ) = κ \{ {α}_{1} + 2 {α}_{2} V ( 1 , \text{:} ) + 3 {α}_{3} V ( 1 , \text{:} ) ⊗ V ( 1 , \text{:} ) + … + \\ N {α}_{N} {\prod }_{⊗}^{N - 1} V ( 1 , \text{:} ) , \\ U ( L , \text{:} ) - {α}_{2} {A}_{CRC 2 : L - 1} - 3 {α}_{3} V ( 1 , \text{:} ) ⊗ {A}_{CRC 2 : L - 1} - \\ {α}_{3} {\sum }_{i = 2}^{L - 2} V ( i , \text{:} ) {A}_{CRC 2 : L - i} - … - \\ {α}_{N} \{ ( N - 1 ) ( {\prod }_{⊗}^{N - 2} V ( 1 , \text{:} ) ) ⊗ {A}_{CRC 2 : L - 1} + ( N - 2 ) ( {\prod }_{⊗}^{N - 3} V ( 1 , \text{:} ) ) ⊗ \\ {\sum }_{i = 1}^{ L - 2} V ( i , \text{:} ) ⊗ {A}_{ CRC 2 : L - 1} + … + {\sum }_{m = 1}^{L - 3} V ( m , \text{:} ) ⊗ \\ {\sum }_{k = 1}^{L - m - 2} V ( k , \text{:} ) ⊗ … ⊗ {\sum }_{j = 1}^{L - m - k - …} \\ {\sum }_{j = 1}^{L - m - k - …} V ( j , \text{:} ) ⊗ {\sum }_{i = 2}^{L - m - j - k - …} V ( i : 1 ) ⊗ {A}_{CRC 2 : L - m - k - i - j - …} \}\end{matrix}$$

where A_{CRCr:s} is as defined in (36).

Although specific embodiments have been illustrated and described herein, it will be appreciated by those of ordinary skill in the art that any arrangement that is calculated to achieve the same purpose may be substituted for the specific embodiments shown. This application is intended to cover any adaptations or variations of embodiments of the present invention. It is to be understood that the above description is intended to be illustrative, and not restrictive, and that the phraseology or terminology employed herein is for the purpose of description and not of limitation. Combinations of the above embodiments and other embodiments will be apparent to those of skill in the art upon studying the above description. The scope of the present invention includes any other applications in which embodiment of the above concepts and methods are used, and the scope of the embodiments of the present invention should be determined with reference to claims associated with these embodiments, along with the full scope of equivalents to which such claims are entitled.

We claim:

1. A method of simulating a nonlinear system comprising:
modeling a nonlinear system, wherein the nonlinear system comprises an unknown signal;
forming a frequency domain representation of the nonlinear system, wherein the frequency domain representation takes the form of an inverse convolution equation;
solving the ICE through a non-iterative method to determine the unknown signal; and
outputting the unknown signal.

2. The method of claim 1 wherein nonlinear components of the frequency domain representation are represented by cascading self-convolutions.

3. The method of claim 1 further comprising determining an order of the ICE.

4. The method of claim 3 wherein determining an order of the ICE comprises setting the order of the ICE to the greatest number of self-convolutions exhibited by a nonlinear component of the nonlinear system.

5. The method of claim 3 wherein the non-iterative method is adjusted for the order of the ICE.

6. The method of claim 1 wherein the ICE is of the form:
$$U = {\sum }_{n = 0}^{N} {α}_{n} {\prod }_{⊗}^{n} ( VA )$$
where U=[U₁ U₂ . . . U_{L}]εC^{L} is a known vector with length L, V=[V₁ V₂ . . . V_{L}]εC^{L} is a vector of unknown state variables, A is a known block matrix, and α=[αₙ] is a known set of polynomial coefficients derived from the frequency domain model of the system, and N is the order of the ICE.

7. The method of claim 6 wherein the non-iterative method for solving the ICE uses the following solution:
$${V}_{1} = {min}_{{V}_{1}} \{ {α}_{1} {V}_{1} + {α}_{2} {V}_{1}^{2} + … + {α}_{N} {V}_{1}^{N} - {U}_{1} = 0 \}$$
$${V}_{2} = \frac{{U}_{2}}{{α}_{1} + 2 {α}_{2} {V}_{1} + 3 {α}_{3} {V}_{1}^{2} + … + N {α}_{N} {V}_{1}^{N - 1}}$$
$$⋮$$
$$\begin{matrix}{V}_{L} = \frac{{U}_{L} - {α}_{2} {A}_{2 : L - 1} - 3 {α}_{3} {V}_{1} {A}_{2 : L - 1} - {α}_{3} {\sum }_{i = 2}^{L - 2} {V}_{i} {A}_{2 : L - i}}{{α}_{1} + 2 {α}_{2} {V}_{1} + 3 {α}_{3} {V}_{1}^{2} + … + N {α}_{N} {V}_{1}^{N - 1}} - … - \\ \frac{{α}_{N} \{ ( N - 1 ) {V}_{1}^{( N - 2 )} {A}_{2 : L - 1} + ( N - 2 ) {V}_{1}^{( N - 3 )} {\sum }_{i = 1}^{L - 2} {V}_{i} {A}_{2 : L - i} + …}{{α}_{1} + 2 {α}_{2} {V}_{1} + 3 {α}_{3} {V}_{1}^{2} + … + N {α}_{N} {V}_{1}^{N - 1}} … \\ \frac{… + {\sum }_{m = 1}^{L - 3} {V}_{m} {\sum }_{k - 1}^{L - m - 2} {V}_{k} … {\sum }_{m = 1}^{L - 3} {V}_{j} {\sum }_{k - 1}^{L - m - 2} {V}_{i} {A}_{2 : L - m - k - i - j - …} \}}{{α}_{1} + 2 {α}_{2} {V}_{1} + 3 {α}_{3} {V}_{1}^{2} + … + N {α}_{N} {V}_{1}^{N - 1}}\end{matrix}$$
$$where$$
$${A}_{r : s} = {\sum }_{i = r}^{s} {V}_{s - i + 1} {V}_{i}$$

8. The method of claim 1 further comprising the step of forming a time domain representation of the nonlinear system, wherein the frequency domain representation of the system is a frequency domain transformation of the time domain representation.

9. The method of claim 8 wherein the frequency domain representation of the nonlinear system is the Fourier transformation of the time domain model.

10. The method of claim 1 wherein the nonlinear system is an electrical circuit.

11. A method of simulating a nonlinear system comprising:
modeling a nonlinear system, wherein the nonlinear system comprises an unknown signal;
forming a cross-referenced coordinate (CRC) representation of the nonlinear system;
representing the system as a CRC-based inverse convolution equation (ICE) by transforming the CRC representation of the system into an ICE; and
solving the CRC-based ICE through a non-iterative method to determine the unknown signal; and
outputting the unknown signal.

12. The method of claim 11 wherein nonlinear components of the frequency domain representation are represented by cascading self-convolutions.

13. The method of claim 11 further comprising determining an order of the CRC-based ICE.

14. The method of claim 13 wherein determining an order of the CRC-based ICE comprises setting the order of the CRC-based ICE to the greatest number of self-convolutions exhibited by a nonlinear component of the nonlinear system.

15. The method of claim 13 wherein the non-iterative method is adjusted for the order of the CRC-based ICE.

16. The method of claim 11 wherein the CRC-based ICE is of the form:
$$U = {\sum }_{n = 0}^{N} {α}_{n} {\prod }_{{⊗}_{CRC}}^{n} ( V * A ) \\ where \\ {\prod }_{{⊗}_{CRC}}^{n} X = \overbrace{X {⊗}_{CRC} X … {⊗}_{CRC} X}^{n} \qquad ( 31 )$$
where U is a known matrix, V is an unknown matrix of state variables in CRC format having L rows, A is a matrix of the same dimensions as V, and αₙ is a set of matrices comprising known system model parameters, where N defines the convolution order of the CRC-based ICE, and where “*” is the array multiplication operator of two matrices.

17. The method of claim 16 wherein the non-iterative method comprises the following L-step process:
Step 1: Calculating V(1,:), the first row of matrix V, by solving the following equation:
$$V ( 1 , \text{:} ) = {α}_{1} V ( 1 , \text{:} ) + {α}_{2} V ( 1 , \text{:} ) {⊗}_{CRC} V ( 1 , \text{:} ) + {α}_{2} V ( 1 , \text{:} ) {⊗}_{CRC} V ( 1 , \text{:} ) {⊗}_{CRC} V ( 1 , \text{:} ) + ⋯ + {\prod }_{⊗}^{N} V ( 1 , \text{:} )$$
Step 2: Calculating V(2,:), the second row of matrix V, by performing the following deconvolution:
$$\begin{matrix}V ( 2 , \text{:} ) = κ \{ {α}_{1} + 2 {α}_{2} V ( 1 , \text{:} ) + 3 {α}_{3} V ( 1 , \text{:} ) ⊗ V ( 1 , \text{:} ) + ⋯ + N {α}_{N} {\prod }_{⊗}^{N - 1} , U ( 2 , \text{:} ) \} \\ …\end{matrix}$$
Step L: Calculating V(L,:), the last row of matrix V, by performing the following deconvolution:
$$\begin{matrix}\begin{matrix}V ( L , \text{:} ) = κ \{ {α}_{1} + 2 {α}_{2} V ( 1 , \text{:} ) + 3 {α}_{3} V ( 1 , \text{:} ) ⊗ V ( 1 , \text{:} ) + … + \\ N {α}_{ N} {\prod }_{ {⊗}_{CRC}}^{ n} V ( 1 , \text{:} ) , U ( L , \text{:} ) - {α}_{2} {A}_{CRC 2 : L - 1} - 3 {α}_{3} V ( 1 , \text{:} ) - \\ {α}_{3} {\sum }_{i = 2}^{L - 2} V ( 1 , \text{:} ) {A}_{CRC 2 : L - i} - … - \\ {α}_{N} \{ ( N - 1 ) ( {\prod }_{⊗}^{N - 2} V ( 1 , \text{:} ) ) ⊗ {A}_{CRC 2 : L - 1} + ( N - 2 ) ( {\prod }_{⊗}^{N - 2} V ( 1 , \text{:} ) ) ⊗ \\ {\sum }_{i = 1}^{L - 2} V ( i , \text{:} ) ⊗ {A}_{CRC 2 : L - 1} + … + {\sum }_{m = 1}^{L - 3} V ( m , \text{:} ) ⊗ {\sum }_{k = 1}^{L - m - 2} V ( k , \text{:} ) ⊗ … ⊗ \\ {\sum }_{j = 1}^{L - m - k - …} V ( j , \text{:} ) ⊗ {\sum }_{i = 2}^{L - m - j - k - …} V ( i , : ) ⊗ {A}_{CRC 2 : L - m - k - …} \}\end{matrix} & \\ where \\ {A}_{CRCr : s} = {\sum }_{i = r}^{s} V ( s - i + 1 , \text{:} ) ⊗ V ( i , \text{:} ) & \end{matrix}$$

18. The method of claim 11 further comprising the step of forming a time domain representation of the nonlinear system, wherein the CRC representation of the system is based on the time domain representation.

19. The method of claim 11 wherein the nonlinear system is an electrical circuit.

20. A method of solving a nonlinear inverse convolution equation (ICE), the method comprising:
receiving an ICE of the form:
$$U = {\sum }_{n = 0}^{N} {α}_{n} {\prod }_{⊗}^{n} ( VA )$$
where U=[U₁ U₂ . . . U_{L}]εC^{L} is a known vector with length L, V=[V₁ V₂ . . . V_{L]εC}^{L} is a vector of unknown state variables, A is a known block matrix, α=[αₙ] is a known set of polynomial coefficients derived from the frequency domain model of the system, and N is the order of the ICE;
solving the ICE using the following method:
$${V}_{1} = {min}_{{V}_{1}} \{ {α}_{1} {V}_{1} + {α}_{2} {V}_{2}^{2} + … + {α}_{N} {V}_{1}^{N} - {U}_{1} = 0 \}$$
$${V}_{2} = \frac{{U}_{2}}{{α}_{1} + 2 {α}_{2} {V}_{1} + 3 {α}_{3} {V}_{1}^{2} + … + N {α}_{N} {V}_{1}^{N - 1}}$$
$$⋮$$
$$\begin{matrix}{V}_{L} = \frac{{U}_{L} - {α}_{2} {A}_{2 : L - 1} - 3 {α}_{3} {V}_{1} {A}_{2 : L - 1} - {α}_{3} {\sum }_{i = 2}^{L - 2} {V}_{i} {A}_{2 : L - i}}{{α}_{1} + 2 {α}_{2} {V}_{1} + 3 {α}_{3} {V}_{1}^{2} + … + N {α}_{N} {V}_{1}^{N - 1}} - … - \\ \frac{{α}_{N} \{ ( N - 1 ) {V}_{1}^{( N - 2 )} {A}_{2 : L - 1} + ( N - 2 ) {V}_{1}^{( N - 3 )} {\sum }_{i = 1}^{L - 2} {V}_{i} {A}_{2 : L - i} + …}{{α}_{1} + 2 {α}_{2} {V}_{1} + 3 {α}_{3} {V}_{1}^{2} + … + N {α}_{N} {V}_{1}^{N - 1}} … \\ \frac{… + {\sum }_{m = 1}^{L - 3} {V}_{m} {\sum }_{k - 1}^{L - m - 2} {V}_{k} … {\sum }_{m = 1}^{L - 3} {V}_{j} {\sum }_{k - 1}^{L - m - 2} {V}_{i} {A}_{2 : L - m - k - i - j - …} \}}{{α}_{1} + 2 {α}_{2} {V}_{1} + 3 {α}_{3} {V}_{1}^{2} + … + N {α}_{N} {V}_{1}^{N - 1}}\end{matrix}$$
$$where$$
$${A}_{r : s} = {\sum }_{i = r}^{s} {V}_{s - i + 1} {V}_{i} ; and$$
$$outputting the vector V .$$
